(19) United States
(12) Patent Application Publication
(10) Pub. No.: US 2008/0284735 A1
(43) Pub. Date: Nov. 20, 2008

(54) Multi-Purpose Optical Mouse

(76) Inventor: Theodore I. Shim, Palo Alto, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/750,860

(22) Filed: May 18, 2007

(51) Int. Cl. G06F 3/033

(52) U.S. Cl. 345/166

(57) ABSTRACT

An optical pointing device has a rotatable optics housing and provides cursor control in one of two modes: a finger navigation mode and a desktop navigation mode. In the finger navigation mode, the rotatable optics housing is in a first position and moving a finger across a transparent plate in the optics housing controls the cursor movement. In the desktop navigation mode, the rotatable optics housing is in a second position and moving the entire optical mouse in a conventional manner across a fixed surface controls cursor movement. The optical pointing device may further include a touchpad scroll input device and a laser pointing device.

### BACKGROUND OF THE INVENTION

1. Field of the Invention

Embodiments of the present invention relate generally to pointing devices for computing devices, and in particular, to a multi-purpose optical mouse.

2. Description of the Related Art

Computers are increasingly being used for graphical presentations that are displayed to a group of people. Many presentations, such as slide shows, require relatively simple control of the computer, such as commands for advancing or moving back through slides. For these, simple input devices with user-actuated buttons for advancing or moving back through the presentation have been developed. Some presentations require a more sophisticated control of the computer. For these, it is necessary for the presenter to remain in close proximity of the computer to operate a conventional pointing device, such as a mouse, trackball, touchpad, etc.

U.S. Pat. No. 7,161,578 discloses a pointing device that is particularly suitable for use during presentations. The device integrates a laser pointer and a pointing device, and is operable wirelessly so that it does not restrict the mobility of the presenter. It is also configured similar to a pen so that it can be easily operable with one hand. The device provides portability and enables multiple functions, but the different functional components are housed in a very inefficient manner. As a result, ease of use is a problem with this device. For example, the orientation of the device has to be flipped whenever the presenter desires to change the use of the device, i.e., from a pointing device to a laser pointer or from a laser pointer to a pointing device.

### SUMMARY OF THE INVENTION

The present invention provides a pointing device that is simple to operate in a presentation environment and is operable as a presentation input device and as a conventional desktop input device. The pointing device according to embodiments of the present invention is configured with a rotatable optics housing and provides cursor control in one of two modes: a finger navigation mode and a desktop navigation mode. In the finger navigation mode, the rotatable optics housing is in a first position and moving a finger across a transparent plate in the optics housing controls the cursor movement. In the desktop navigation mode, the rotatable optics housing is in a second position and moving the entire optical mouse in a conventional manner across a fixed surface controls cursor movement. The optical input device may further include a touchpad scroll input device and a laser pointing device.

According to one embodiment, a pointing device for a computing device comprises a first section having an upper surface on which at least one button configured to be pressed by a user is formed and a second section having a first surface with an opening, an illumination device for projecting light through the opening, and an optical sensor aligned with the opening for detecting light reflected from an external object proximate the opening. The second section is rotatable with respect to the first section to one of a first operating position and a second operating position. In the first operating position, the first surface of the second section faces the same direction as the upper surface of the first section. In the second operating position, the first surface of the second section and the upper surface of the first section face opposite directions.

According to another embodiment, a pointing device for a computer having two operable positions comprises a first section and a second section that is configured to be rotatable with respect to the first section, the second section having an opening through which relative movement of the input device and an external object that is proximate the opening can be detected. The opening is directed upwards in a first operable position of the input device and downwards in a second operable position of the input device. The second section may further include an optical beam source positioned within the second section to project light through the opening and an optical sensor positioned within the second section to detect light reflected from an external object proximate the opening.

According to another embodiment, a reconfigurable input device for a computing device comprises a first section and a second section that is rotatable with respect to the first section to attain one of a first operating position and a second operating position. The reconfigurable input device is operable as a presentation mouse having a finger navigation sensor when the second section is in the first operating position, and as a conventional desktop optical mouse when the second section is in the second operating position.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates an optical mouse in the finger navigation mode.

FIG. 1B illustrates an optical mouse in the desktop navigation mode.

FIG. 2A is a partial schematic side view of an exemplary configuration of an optical assembly with an optical mouse deployed in the finger navigation mode.

FIG. 2B is a partial schematic side view of an exemplary configuration of an optical assembly with an optical mouse deployed in the desktop navigation mode.

FIG. 2C illustrates the position of the optical assembly relative to its housing when the optical mouse is deployed in the finger navigation mode.

FIG. 2D illustrates the position of the optical assembly relative to its housing when the optical mouse is deployed in the desktop navigation mode.

FIG. 3A is a partial schematic cross-sectional view of one configuration of capacitive switch that may be incorporated into embodiments of the invention.

FIG. 3B is a partial schematic cross-sectional view of one configuration of capacitive pressure switch that may be incorporated into embodiments of the invention.

FIG. 3C is a schematic cross-sectional view of an optical assembly combined with a mechanical control switch that may be incorporated into embodiments of the invention.

FIG. 4 is a partial schematic cross-sectional view of a control button assembly illustrating one configuration of touchpad scroll input device that may be incorporated into embodiments of the invention.

FIG. 5 is a schematic view of one configuration of diode laser that may be incorporated into embodiments of the invention.

For clarity, identical reference numerals have been used, where applicable, to designate identical elements that are common between figures. It is contemplated that features of one embodiment may be incorporated in other embodiments without further recitation.

### DETAILED DESCRIPTION

Embodiments of the invention contemplate a pointing device for a computing device having a rotatable optics housing, which may provide cursor control in one of two modes: a finger navigation mode and a desktop navigation mode. In the finger navigation mode, the rotatable optics housing is in a first position and moving a finger across a transparent plate in the optics housing controls the cursor movement. In the desktop navigation mode, the rotatable optics housing is in a second position and moving the entire optical mouse in a conventional manner across a fixed surface controls cursor movement.

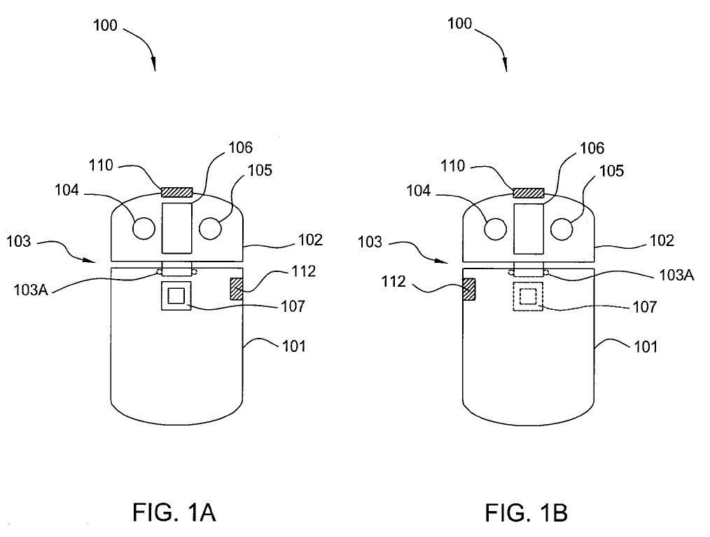

FIGS. 1A and 1B illustrate schematic plan views of an optical mouse 100 that is employed as a pointing device according to embodiments of the invention. Optical mouse 100 is relatively small in size to facilitate use as a hand-held computer input device, and includes an optical housing 101 coupled to a control button assembly 102 by a rotary coupling 103. Rotary coupling 103 includes a cylindrical sleeve that is integral with control button assembly 102 and inserts into a corresponding opening in optical housing 101. Rotary coupling 103 also includes a liquid-resistant seal 103A, such as an O-ring seal, disposed on the outer circumference of the cylindrical sleeve and in contact with the inner wall of the opening in optical housing 101. The liquid-resistant seal 103A prevents infiltration of moisture and other contaminants into the interior of optical mouse 100.

Control button assembly 102 includes a left button 104, a right button 105, and a touchpad scroll input device 106 positioned on a top, or upward-facing surface. Control button assembly 102 also includes a diode laser 110 for use as a laser pointer when optical mouse 100 is used in the finger navigation mode. A laser activation switch 112 is located as shown for activating and deactivating diode laser 110. Rotary coupling 103 allows optical housing 101 to be configured in the finger navigation mode (FIG. 1A) or the desktop navigation mode (FIG. 1B).

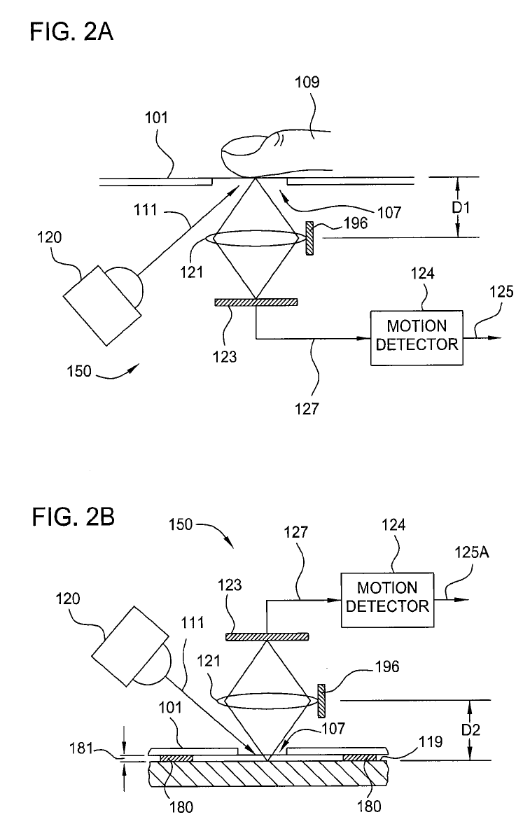

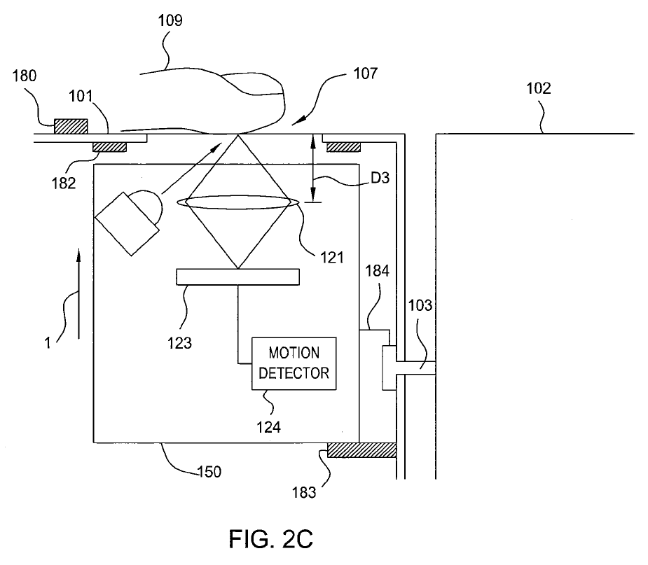

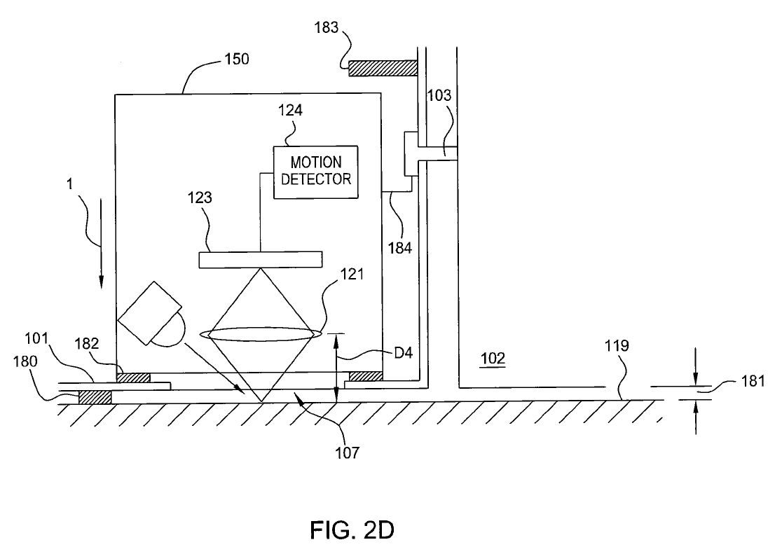

Optical housing 101 contains an optical assembly 150, described below in conjunction with FIGS. 2A and 2B, and a transparent plate 107, which is disposed on a top or bottom surface of optical mouse 100, depending on the mode in which optical mouse 100 is operating. Other components of optical mouse 100 contained in optical housing 101, which are not shown, include an internal power source, power management electronics, a radio frequency (RF) unit, an RF antenna assembly, and a microprocessor unit. The internal power source supplies power to the electrically powered components of optical mouse 100. For example, the internal power source may include two 1.5 V batteries. The power management electronics are configured to extend power source life by placing components of optical mouse 100 in a sleep mode or off state, when appropriate. For example, the RF unit may be placed in an off state when optical mouse 100 is not transmitting information to a computer, and optical mouse 100 may be placed in a sleep mode when not used for a suitable time interval. The RF unit may be a conventional RF transceiver that communicates with a computer with RF signals via the RF antenna assembly. The RF antenna assembly may be a loop or whip antenna system, may be contained entirely inside optical housing 101, and facilitates wireless communication between optical mouse 100 and a computer. The microprocessor unit may be a conventional microprocessor with a memory cache and provides operational control over the functions of optical mouse 100.

FIG. 1A illustrates optical mouse 100 in the finger navigation mode. In this mode, optical housing 101 is rotated relative to control button assembly 102 so that transparent plate 107 is oriented facing up. In this mode, a user may move a finger or thumb across the surface of transparent plate 107 to control cursor movement in two dimensions on a computer display.

FIG. 1B illustrates optical mouse 100 in the desktop navigation mode. In this mode, optical housing 101 is rotated relative to control button assembly 102 so that transparent plate 107 is oriented facing downward and optical mouse 100 is positioned on a supporting surface, such as a desktop or mousepad. Movement of optical mouse 100 relative to the desktop, mousepad, or other supporting surface controls the two-dimensional cursor position on a computer display.

According to one embodiment of the invention, the components in control button assembly 102 function differently depending on the mode of operation. In the finger navigation mode, diode laser 110 is enabled so that it can be used as a laser pointer. Either left button 104 or right button 105 may be configured to activate diode laser 110. The other button is then configured for normal mouse button operations. In the desktop navigation mode, diode laser 110 is disabled and left button 104 and right button 105 are configured for normal mouse button operations. In both modes, touchpad scroll input device 106 is configured for scroll input operations.

A position switch or sensor is incorporated into rotary coupling 103 so that the microprocessor unit for optical mouse 100 can sense the current mode of navigation, i.e., either the finger navigation mode or the desktop navigation mode. With this information, the microprocessor selectively changes the configuration of the control buttons, e.g., left button 104 and right button 105, and enables or disables diode laser 110, depending on the current navigation mode of optical mouse 100. Further, the microprocessor unit utilizes different motion detection and cursor control algorithms depending on the current navigation mode of optical mouse 100. The different control algorithms are discussed below in conjunction with FIGS. 2A and 2B.

In the example depicted in FIGS. 1A and 1B, optical mouse 100 is a wireless mouse and is configured to transmit cursor control data to a computer via an RF signal. Alternatively, optical mouse 100 may be configured to communicate with a computer via an infrared connection or a conventional hard-wired connection.

FIG. 2A is a partial schematic side view of an exemplary configuration of optical assembly 150, where optical mouse 100 is deployed in the finger navigation mode. Optical assembly 150 includes transparent plate 107 that covers a light aperture for optical cursor control and is positioned on an upper surface of optical housing 101. During finger navigation, a digit 109 of a user is placed on the transparent plate and maneuvered so as to control the motion of the cursor on a computer display. As shown, optical assembly 150 also contains the other requisite optical components for an optical mouse, including a light source 120, a light guiding element 121, a two-dimensional optical sensor array 123, and a motion detector unit 124. Additional optical elements may also be contained in optical housing 101, depending on the internal configuration of optical mouse 100, such as reflective surfaces or prisms, which may be positioned to more favorably direct light through transparent plate 107. For example, a prism may be positioned between light source 120 and transparent plate 107 to improve the angle of incidence of output light 111 onto transparent plate 107.

Light source 120 may be an LED light source, a laser diode, or other light source known in the art, and is positioned to direct output light 111 produced thereby through transparent plate 107 to illuminate the surface of digit 109 (e.g., a user's finger or thumb) when it is placed proximate transparent plate 107. Light guiding element 121 may be a lens, prism, mirror, optical fiber, or other means known in the art for directing light reflected from digit 109 to optical sensor array 123 for image processing. In the example illustrated in FIG. 2A, light guiding element 121 is a focusing lens. Optical sensor array 123 is positioned to be optically coupled to digit 109 by light-guiding element 121, and may consist of CMOS image sensors or charge-coupled device (CCD) image sensors. In either case, the image sensors are arranged in a two-dimensional pattern that is parallel to transparent plate 107 to facilitate processing of images projected therethrough. Motion detector unit 124 consists of microcircuitry configured to process consecutive images produced by optical sensor array 123, and determines motion of optical mouse 100. Alternatively, the functions of motion detector unit 124 may be incorporated into the microprocessor unit of optical mouse 100.

In operation, output light 111 of optical mouse 100 is emitted by light source 120, directed through transparent plate 107, and illuminates the surface of digit 109. The light reflected from digit 109 forms an image on the surface of optical sensor array 123 through light guiding element 121, and the formed image is converted into a digital image that is communicated to motion detector component 124 as an output signal 127. Output signal 127 is then processed by motion detector unit 124. Motion detector unit 124 compares the image contained in output signal 127 to the preceding digital image produced by optical sensor array 123, and determines the magnitude and direction of cursor motion requested via a cursor control algorithm. A cursor motion signal 125 is then output to the computer being controlled by optical mouse 100.

FIG. 2B is a partial schematic side view of an exemplary configuration of optical assembly 150, where optical mouse 100 is in the desktop navigation mode. Optical housing 101 is rotated relative to control button assembly 102 so that transparent plate 107 is oriented downward, as depicted in FIG. 1B, and optical mouse 100 rests on a supporting surface 119. Supporting surface 119 may be any relatively flat, fixed surface having a detectable pattern, such as a desktop or mousepad, on which optical mouse 100 is placed for controlling a computer in a conventional manner.

In this mode, the organization and operation of optical assembly 150 is essentially identical to the finger navigation mode, with two exceptions. First, optical housing 101 is rotated relative to control button assembly 102 so that transparent plate 107 and the light aperture covered by transparent plate 107 are oriented downward, as described above. Second, motion detector unit 124 uses a modified cursor control algorithm to generate cursor motion signal 125A. The modified cursor control algorithm used to generate cursor motion signal 125A in the desktop navigation mode differs from the cursor control algorithm used to generate cursor motion signal 125 in the finger navigation mode in order to compensate for the change in vertical response of a cursor control device when “flipped,” i.e., when rotated from a face-up to a face-down orientation or vice versa. This change in response of a cursor control device stems from the fact that the relative motion that occurs when moving optical mouse 100 “downward” in the desktop navigation mode is the same as the relative motion produced by moving a finger “upward” across transparent plate 107 in the finger navigation mode. Hence, motion detector unit 124 uses different cursor control algorithms for each navigation mode. In this way, moving optical mouse 100 downward in the desktop navigation mode produces the same on-screen cursor response as moving a finger downward across transparent plate 107 in the finger navigation mode.

According to one embodiment, optical mouse 100 is provided with stand-off footers 180 to prevent supporting surface 119 from scratching transparent plate 107 when optical mouse 100 is in the desktop navigation mode. Stand-off footers 180 ensure that a gap 181 is present between supporting surface 119 and the surface of transparent plate 107. Gap 181 may adversely affect the ability of light guiding element 121 to focus an image of support surface 119 onto optical sensor array 123, since the distance D2 between light guiding element 121 and support surface 119 is greater than the distance D1 (shown in FIG. 2A) between light guiding element 121 and the surface of digit 109. Therefore, optical assembly 150 is provided with an auto-focus mechanism that controls the position of light guiding element 121 so that the reflected image is properly focused onto optical sensor array 123. The auto-focus mechanism includes an actuator 196 that operates under control of the microprocessor unit of optical mouse 100.

In another embodiment, the position of the entire optical assembly 150 is moved relative to transparent plate 107 whenever optical mouse 100 is changed from one navigation mode to another, so that the reflected image is properly focused onto optical sensor array 123. FIG. 2C illustrates the position of the optical assembly relative to its housing when the optical mouse is deployed in the finger navigation mode. FIG. 2D illustrates the position of the optical assembly relative to its housing when the optical mouse is deployed in the desktop navigation mode.

In the finger navigation mode, optical assembly 150 is positioned so that light guiding element 121 is located a distance D3 from transparent plate 107 and the surface of digit 109. When optical mouse 100 is deployed in the desktop navigation mode, optical assembly 150 is repositioned inside optical housing 101 to be closer to transparent plate 107 by a displacement equal to gap 181. In this way, a distance D4 between light guiding element 121 and supporting surface 119 is equal to distance D3 between light guiding element 121 and the surface of digit 109 when optical mouse 100 is deployed in the finger navigation mode. This repositioning of optical assembly 150 inside optical housing 101 allows a well-focused image of support surface 119 to be directed onto optical sensor array 123 in the desktop navigation mode and of the surface of digit 109 in the finger navigation mode.

Optical assembly 150 is moved relative to transparent plate 107 by a mechanical linkage 184 coupled to rotary coupling 103. Any mechanical linkages suitable for providing a linear displacement of optical assembly 150 when actuated by a relative rotary motion between optical assembly 101 and control button assembly 102 may be used. Referring to FIG. 2C, when optical mouse 100 is converted from the finger navigation mode to the desktop navigation mode, optical housing 101 is rotated relative to control button assembly 102 and mechanical linkage 184 displaces optical assembly in the direction indicated by arrow 1, i.e., toward transparent plate 107. Conversely, referring to FIG. 2D, when optical mouse 100 is converted from the desktop navigation mode to the finger navigation mode, optical housing 101 is rotated relative to control button assembly 102 and mechanical linkage 184 displaces optical assembly in the direction indicated by arrow 2, i.e., away from transparent plate 107.

In addition, optical housing 101 is configured with mechanical stops 182 and 183 to positively define the limits of motion of optical assembly 150 in the directions indicated by arrows 1 and 2, respectively. In the finger navigation mode, mechanical linkage 184 holds optical assembly 150 against mechanical stop 183 and in the desktop navigation mode, mechanical linkage 184 holds optical assembly 150 against mechanical stops 182. Hence, in each navigation mode, the position of optical assembly 150 is constrained by a precisely placed member, i.e., mechanical stops 182 or 183, thereby ensuring reliable positioning of optical assembly 150 without the need for calibration or maintenance of mechanical linkage 184.

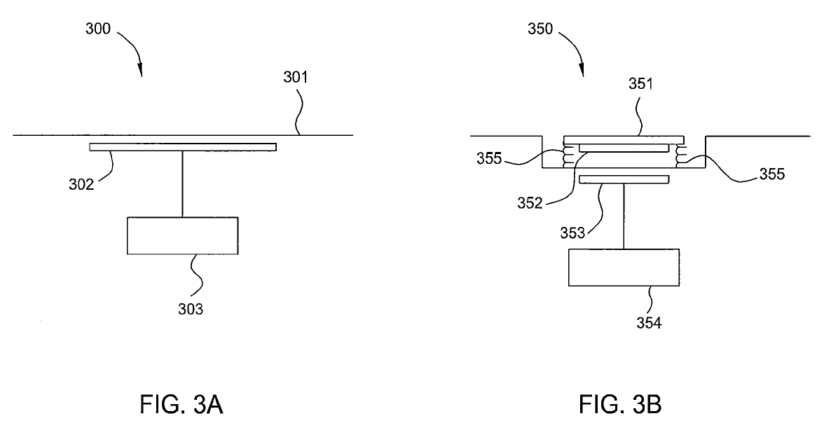

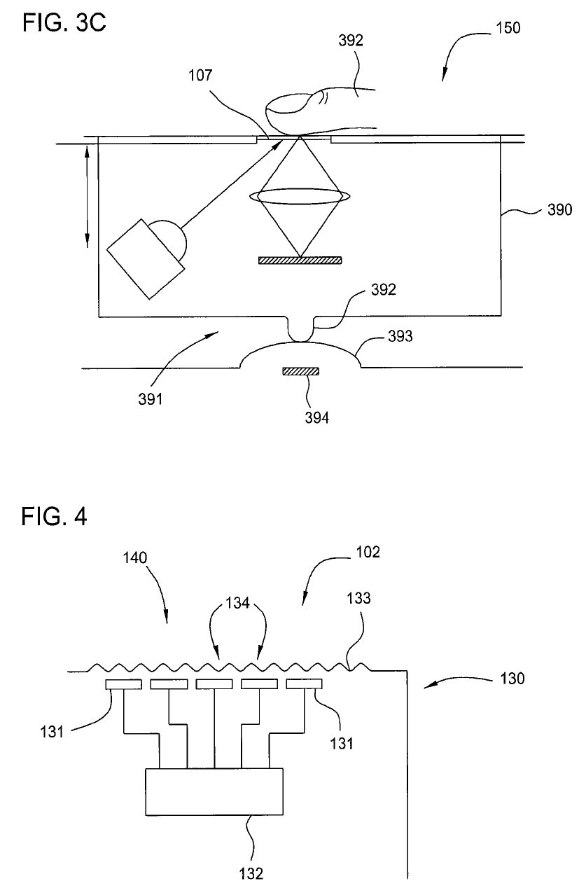

FIG. 3A is a partial schematic cross-sectional view of one configuration of capacitive switch that may be incorporated into embodiments of the invention. Capacitive switch 300, shown in FIG. 3A, may used in lieu of a mechanical switch, such as left button 104 and right button 105. Capacitive switch 300 includes a conductive plate 302 positioned proximate a dielectric surface 301. A capacitance measurement circuit 303 monitors the capacitance to ground of conductive plate 302. When a finger (not shown) touches the surface of dielectric surface 301, the capacitance to ground of conductive plate 302 increases beyond a predetermined threshold set by capacitance measurement circuit 303. When no finger is present, the capacitance to ground of conductive plate 302 is below the threshold. By comparing the capacitance of conductive plate 302 to the threshold, capacitance measurement circuit 303 can generate a digital signal which is equivalent to the signal produced by a mechanical switch. Depending on the threshold setting, capacitive switch 300 may not even require contact with a user's finger, and can be activated solely by proximity of a finger.

In some applications, a pressure-sensitive switch or button is more desirable than a touch-sensitive switch. Embodiments of the invention contemplate a pointing device having one or more control buttons configured with a capacitive pressure switch, such as pressure switch 350, illustrated in FIG. 3B. Pressure switch 350, shown in FIG. 3B, may used in lieu of a mechanical switch, such as left button 104 and right button 105.

FIG. 3B is a partial schematic cross-sectional view of one configuration of capacitive pressure switch that may be incorporated into embodiments of the invention. Pressure switch 350 includes a movable button 351, a conductive plate 353, a spring mechanism 355, and a capacitance measuring circuit 354. Button 351 has a conductive plate 352 making up a lower portion of pressure switch 350 that is positioned adjacent and electrically isolated from conductive plate 353. A variety of springs, including metal springs, compressible foam, or single-piece enclosures with buttons made of elastic material, may be used as spring mechanism 355. Pressure on button 351 brings conductive plate 352 closer to conductive plate 353, thus increasing the capacitance therebetween. Capacitance measuring circuit 354 detects this change in capacitance and produces a signal once a predetermined threshold capacitance is exceeded. By requiring more than simply contact or proximity to a finger for activation, pressure switch 350 is similar to a conventional mechanical switch, but is more resistant to contamination and wear, since button activation does not require an electrical contact to be made.

In some embodiments, transparent plate 107 is configured to include a capacitive switch 300 or pressure switch 350 at the periphery of the light aperture to act as an activation button for a power consuming function of optical mouse 100, when the optical mouse is in the finger navigation mode. For example, capacitive switch 300 or pressure switch 350 that has been incorporated into transparent plate 107 serves as an activation switch for light source 120, so that light source 120 is turned off and remains off until it is activated by a finger. In another example, capacitive switch 300 or pressure switch 350 that has been incorporated into transparent plate 107 serves as an activation switch for diode laser 110. With this configuration, either left button 104 or right button 105 need not be reserved for laser activation and both can be used for normal mouse button operations. Since a user generally does not need to simultaneously control a cursor and operate a laser pointer, power consumption is minimized in this configuration by programming the microprocessor of optical mouse 100 to deactivate light source 120 when the pressure switch incorporated into transparent plate 107 is activated.

FIG. 3C is a schematic cross-sectional view of an optical assembly 390 combined with a mechanical control switch that may be incorporated into embodiments of the invention. The mechanical switch provides a secondary control function to the cursor control function of transparent plate 107. Optical assembly 390 is substantially identical in organization and operation to optical assembly 150 shown in FIGS. 2A and 2B, with the additional feature of mechanical switch 391. In the example depicted in FIG. 3C, mechanical switch 391 is a dome switch and is positioned on the bottom of optical assembly 390. Mechanical switch 391 is activated by downward pressure from a navigation digit 392 of a user. The downward pressure causes a projection 392 to elastically deform dome-shaped conductor 393 until dome-shaped conductor 393 comes into contact with conductive contact 394, thereby activating a control function. Because navigation digit 392 is also used for cursor position control via motion across transparent plate 107, the user may perform the secondary function associated with mechanical switch 391 without removing navigation digit 392 from transparent plate 107. Hence, optical assembly 390 allows a user to more easily conduct a computer-based presentation without interruption. In one example, actuation of mechanical switch 391 toggles the laser pointer on or off. Alternatively, the secondary function associated with mechanical switch 391 may be another computer control function, including a single-click function, a double-click function, a page-down function, a menu pull-down function, etc.

FIG. 4 is a partial schematic cross-sectional view of control button assembly 102 illustrating one configuration of touchpad scroll input device 106. In this example, touchpad scroll input device 106 is a capacitive touchpad assembly 140 that operates directly on capacitive sensing principles, and includes no moving parts. Capacitive touchpad assembly 140 contains an array 130 of conductive plates 131 connected to a processor 132 that includes capacitance measuring circuits. Conductive plates 131 are insulated from the user's finger by surface 133 of control button assembly 102, which may be an insulating film, coating, or other thin structure. Surface 133 allows close proximity of a user's finger to conductive plates 131 while electrically insulating the conductive plates 131 from the user's finger, thereby allowing the location of the user's finger to alter the capacitance of one or more conductive plates in array 130. Surface 133 of touchpad scroll input device 106 has texture 134, such as grooves or bumps, to provide the user with a tactile interface. Array 130 may be part of a circuit board contained in capacitive touchpad assembly 140, such as the circuit board containing processor 132. In the example illustrated in FIGS. 1A and 1B, array 130 is positioned between left button 104 and right button 105. Alternatively, array 130, and hence the scroll function control for optical mouse 100, may be positioned in other locations on control button assembly 102 or optical housing 101. For example, array 130 may be positioned on a side of optical housing 101, thereby allowing thumb actuation for more ergonomic scrolling control when optical mouse 100 is in the finger navigation mode.

In operation, processor 132 generates a scrolling signal of a certain direction and distance when a finger motion of a corresponding direction and distance is measured. Capacitive touchpad assembly 140 accurately determines the position of a finger or other conductive object proximate to or touching surface 133 by sensing the capacitance of conductive plates 131. Processor 132 then calculates the motion of a user's finger along touchpad scroll input device 106 by comparing finger positions at successive times, and outputs a suitable scrolling motion signal to the computer being controlled by optical mouse 100.

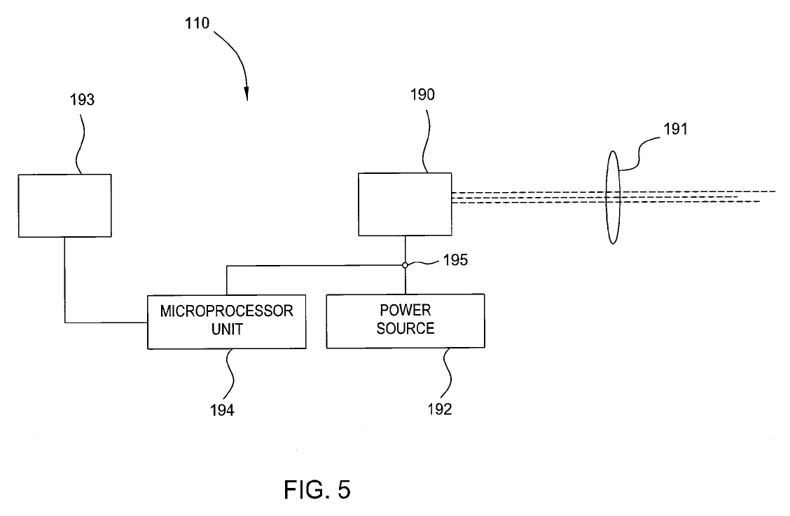

FIG. 5 is a schematic view of one configuration of diode laser 110. Diode laser 110 includes a diode laser source 190, a lens 191, a power source 192, and an activation switch 193. Activation switch 193 may correspond to laser activation switch 112 in FIGS. 1A and 1B. Alternatively, the functions of activation switch 193 may be incorporated into one or more previously described control buttons, including left button 104, right button 105, and transparent plate 107, as described above. Power source 192 may also serve as the power source for other components of optical mouse 100. When activation switch 193 is touched, pressed, toggled, or otherwise activated by a user, a microprocessor unit 194 electrically couples diode laser source 190 to power source 192 through switch 195. Upon activation, diode laser source 190 generates a coherent light beam that passes through lens 191.

According to an embodiment of the invention, an optical mouse is contemplated that is washable, to facilitate the convenient sterilization thereof using decontaminating liquids. Such an optical mouse is particularly desirable in hospitals and other locations in which biological contaminants may be spread between multiple users. In this embodiment, optical mouse 100 includes only non-mechanical control buttons. Scroll input operations are provided by touchpad scroll input device 106, which is a capacitive touchpad assembly, as described above in conjunction with FIG. 4. Left- and right-click operations and laser activation/deactivation functions are provided by capacitive pressure switches, such as pressure switch 350, illustrated in FIG. 3B. Capacitive sensing and capacitive pressure switches may be hermetically sealed from the exterior of optical mouse 100, since no mechanical actuators are required to penetrate the outer surface of optical mouse 101. Likewise, transparent plate 107 is joined to the outer surface of optical mouse 100 in a liquid-resistant manner, i.e., welded or configured with a gasket material. Finally, liquid-resistant seal 103A of rotary coupling 103 prevents penetration of decontaminating liquids into optical mouse 100 via rotary coupling 103. Thus, in this embodiment, optical mouse 100 has a water-proof exterior.

While the foregoing is directed to embodiments of the present invention, other and further embodiments of the invention may be devised without departing from the basic scope thereof, and the scope thereof is determined by the claims that follow.

What is claimed is:

1. A pointing device for a computing device comprising:
a first section having an upper surface on which at least one button configured to be pressed by a user is formed; and
a second section having a first surface with an opening, an illumination device for projecting light through the opening, and an optical sensor aligned with the opening for detecting light reflected from an external object proximate the opening,
wherein the second section is rotatable with respect to the first section to one of a first operating position and a second operating position, the first surface of the second section facing the same direction as the upper surface of the first section in the first operating position, and the first surface of the second section and the upper surface of the first section facing opposite directions in the second operating position.

2. The pointing device according to claim 1, wherein the first section includes a touchpad scroll input device.

3. The pointing device according to claim 2, wherein the first section includes two buttons, one on each side of the touchpad scroll input device.

4. The pointing device according to claim 1, further comprising a laser source.

5. The pointing device according to claim 1, wherein the second section further includes a lens for focusing the reflected light onto the optical sensor and a transparent plate covering the opening.

6. The pointing device according to claim 5, wherein the position of the lens relative to the transparent plate changes when the second section is rotated with respect to the first section.

7. The pointing device according to claim 5, wherein the lens comprises an auto-focusing lens.

8. The pointing device according to claim 5, wherein the second section further includes a switch that is responsive to a finger placed on the transparent plate.

9. The point device of according to claim 8, wherein the switch causes the illumination device to turn on and project light through the opening.

10. A pointing device for a computer having two operable positions comprising a first section and a second section that is configured to be rotatable with respect to the first section, the second section having an opening through which relative movement of the pointing device and an external object that is proximate the opening can be detected, wherein the opening is directed upwards in a first operable position of the pointing device and downwards in a second operable position of the pointing device.

11. The pointing device according to claim 10, wherein the second section further includes an optical beam source positioned within the second section to project light through the opening and an optical sensor positioned within the second section to detect light reflected from an external object proximate the opening.

12. The pointing device according to claim 11, further comprising a button configured to be pressed by a user and a diode laser source that is activated when the button is pressed while the pointing device is in the first operable position.

13. The pointing device according to claim 12, wherein the diode laser source is not activated when the button is pressed while the pointing device is in the second operable position.

14. The pointing device according to claim 10, further comprising a transparent plate covering the opening, a switch that is responsive to a finger placed on the transparent plate, and a diode laser source that is activated by the switch.

15. A reconfigurable pointing device for a computing device, comprising:
a first section; and
a second section that is rotatable with respect to the first section to attain one of a first operating position and a second operating position,
wherein the reconfigurable pointing device is operable as a presentation mouse having a finger navigation sensor when the second section is in the first operating position, and as a conventional desktop optical mouse when the second section is in the second operating position.

16. The reconfigurable pointing device according to claim 15, wherein the first section includes a diode laser that can be activated when the second section is in the first operating position and cannot be activated when the second section is in the second operating position.

17. The reconfigurable pointing device according to claim 15, wherein the finger navigation sensor is configured to sense a movement of a finger relative to the second section and the conventional desktop optical mouse is configured to sense a movement of the second section relative to a surface on which the second section rests.

18. The reconfigurable pointing device according to claim 17, wherein the second section includes an opening that is pointed upwards in the first operating position and downwards in the second operating position.

19. The reconfigurable pointing device according to claim 18, wherein the second section further includes an optical beam source positioned within the second section to project light through the opening, an optical sensor positioned within the second section to detect light reflected from an external object proximate the opening, a lens for focusing the reflected light onto the optical sensor, and a transparent plate covering the opening.

20. The reconfigurable pointing device according to claim 19, wherein the position of the lens relative to the transparent plate changes when the second section is rotated with respect to the first section.

21. A pointing device for a computing device having two modes of operation, comprising:
a water-proof first housing; and
a water-proof second housing that is rotatable with respect to the first section to attain one of a first operating mode and a second operating mode.

22. The pointing device according to claim 21, wherein the pointing device is operable as a presentation mouse having a finger navigation sensor when the second housing is in the first operating mode, and as a conventional desktop optical mouse when the second housing is in the second operating mode.

23. The pointing device according to claim 22, wherein the finger navigation sensor is configured to sense a movement of a finger relative to the second housing and the conventional desktop optical mouse is configured to sense a movement of the second housing relative to a surface on which the second housing rests.

24. The pointing device according to claim 21, wherein the second housing includes an opening that is pointed upwards in the first operating mode and downwards in the second operating mode.

25. The pointing device according to claim 24, wherein the second housing further includes an optical beam source positioned within the second housing to project light through the opening, an optical sensor positioned within the second housing to detect light reflected from an external object proximate the opening, a lens for focusing the reflected light onto the optical sensor, and a transparent plate covering the opening.

26. The pointing device according to claim 25, wherein the position of the lens relative to the transparent plate changes when the second housing is rotated with respect to the first housing.
